(19) United States
(12) Patent Application Publication
(10) Pub. No.: US 2025/0096900 A1
(43) Pub. Date: Mar. 20, 2025

(54) OPTICAL TRANSCEIVER MODULE

(71) Applicant: InnoLight Technology (Suzhou) Ltd., Suzhou (CN)

(72) Inventors: LONG CHEN, Suzhou (CN); YU-ZHOU SUN, Suzhou (CN)

(21) Appl. No.: 18/966,422

(22) Filed: Dec. 3, 2024

Related U.S. Application Data
(63) Continuation of application No. PCT/CN2023/091037, filed on Apr. 27, 2023.

(30) Foreign Application Priority Data
Jun. 10, 2022 (CN) 202221440969.7

(51) Int. Cl. H04B 10/40; H04J 14/02; H04J 14/06

(52) U.S. Cl. CPC H04B 10/40; H04J 14/0213; H04J 14/06

(57) ABSTRACT

An optical transceiving module is provided, including a housing, a circuit board, a bidirectional optical interface, a circulator assembly, an optical transmission assembly, a wavelength division multiplexing assembly, an optical reception assembly and a wavelength division demultiplexing assembly that are disposed in the housing. The optical transmission assembly and the optical reception assembly are electrically connected to the circuit board. The bidirectional optical interface is used for the transmission of combined optical signals. The circulator assembly includes a public optical port, an optical egress port, and an optical ingress port. The optical transmission assembly transmits at least eight transmission-end optical signals. The wavelength division multiplexing assembly combines at least eight transmission-end optical signals, and transmits combined optical signal to the optical ingress port. The wavelength division demultiplexing assembly is to demultiplex the combined optical signal. The optical reception assembly receives at least eight reception-end optical signals.

### CROSS-REFERENCE TO RELATED PATENT APPLICATION

This application is a continuation application of International Patent Application Ser. No. PCT/CN2023/091037 filed on Apr. 27, 2023, and claims the priority of China Patent Application No. CN202221440969.7, filed on Jun. 10, 2022 in People's Republic of China. The entirety of each of the above patent applications is hereby incorporated by reference and made a part of this specification.

### FIELD OF THE DISCLOSURE

The present disclosure relates to the technical field of optical communication, and in particular to an optical transceiver module.

### BACKGROUND TECHNIQUE

With the development of communication technology, optical communication technology has been widely applied in various communication scenarios. Among these applications, optical transceiver modules are indispensable and essential components in the application of optical communication technology, making the structural optimization of these modules a key issue in the technical field of optical communication.

In related technologies, optical transceiver modules typically comprise an optical transmission assembly with multiple transmission channels, an optical reception assembly with multiple reception channels, and multiple optical interfaces. The multiple optical interfaces are respectively coupled with external optical fibers. The multiple transmission channels of the optical transmission assembly are coupled to external optical fibers via a portion of the optical interfaces, while the multiple reception channels of the optical reception assembly are coupled to external optical fibers via another portion of the optical interfaces.

However, in practical applications, existing optical transceiver modules require multiple optical interfaces to couple with multiple optical fibers, resulting in low fiber utilization and an excessive number of optical fibers being used, leading to fiber waste.

### SUMMARY OF THE DISCLOSURE

### Technical Problem

Based on this, it is necessary to provide an optical transceiver module to solve the problem of low utilization rate of optical fibers and the large number of optical fibers used that cause waste of optical fibers.

### Technical Solutions

The present disclosure provides an optical transceiver module, which comprises a housing, and a circuit board, a bidirectional optical interface, a circulator assembly, an optical transmission assembly, a wavelength division multiplexing assembly, an optical reception assembly and a wavelength division demultiplexing assembly that are disposed in the housing, the optical transmission assembly and the optical reception assembly being electrically connected to the circuit board; wherein:
the bidirectional optical interface is used for outputting a combined optical signal externally and receiving a combined optical signal input from outside;
the circulator assembly further comprises a common optical port, an optical output port, and at least one optical incident port, wherein the common optical port is optically coupled to the bidirectional optical interface, the optical output port is optically coupled to the wavelength division demultiplexing assembly, and each of the optical incident ports is optically coupled to the wavelength division multiplexing assembly;
the optical transmission assembly is configured to transmit at least eight transmission-end optical signals;
the wavelength division multiplexing assembly is configured to combine at least eight transmission-end optical signals from the optical transmission assembly and transmit them to the optical incident port;
the wavelength division demultiplexing assembly is configured to demultiplex the combined optical signal output from the optical output port into at least eight reception-end optical signals; and
the optical reception assembly is configured to receive the at least eight reception-end optical signals from the wavelength division demultiplexing assembly.

### BENEFICIAL EFFECTS

In the above-mentioned optical transceiver module, by the cooperation of the bidirectional optical interface and the circulator assembly, the eight-channel optical transmission assembly and the eight-channel optical reception assembly can achieve optical coupling to the bidirectional optical interface through the same common optical port, to make bi-directional transmission over the same fiber, which helps improve the utilization of optical fibers used for network transmission, reduces the number of optical fibers used, and saves optical fiber costs.

### BRIEF DESCRIPTION OF THE DRAWINGS

In order to clearly illustrate the technical solutions of the embodiments or the prior art described in this application, the following briefly introduces the drawings used in the descriptions of the embodiments or the prior art. It is evident that the drawings described below are merely some embodiments of this application. For those skilled in the art, additional drawings may be obtained based on these drawings without requiring creative labor.

FIG. 1 is a schematic view of structural of an optical transceiver module according to an embodiment;

FIG. 2 is a schematic assembly diagram of a TX end (transmission end) according to an embodiment;

FIG. 3 is a schematic assembly diagram of an RX end (reception end) according to an embodiment;

FIG. 4 is a structural schematic diagram of the TX end (transmission end) according to an embodiment;

FIG. 5 is a structural schematic diagram of a circulator assembly according to an embodiment;

FIG. 6 is a schematic optical transmission diagram of a circulator assembly with two optical incident ports according to an embodiment;

FIG. 7 is another schematic optical transmission diagram of a circulator assembly with two optical incident ports according to another embodiment;

FIG. 8 is a schematic optical transmission diagram of a circulator assembly with one optical incident port according to an embodiment;

FIG. 9 is a schematic optical transmission diagram of a first periscope according to an embodiment;

FIG. 10 is a schematic optical transmission diagram of a second periscope according to an embodiment;

FIG. 11 is a structural diagram of the combination of the circulator assembly, the wavelength division demultiplexing assembly, and the optical reception assembly in an optical transceiver module according to an embodiment; and

FIG. 12 is a structural diagram of the combination of the circulator assembly, the wavelength division demultiplexing assembly, and the optical reception assembly in another optical transceiver module embodiment.

### DETAILED DESCRIPTION OF THE EXEMPLARY EMBODIMENTS

To make the above objectives, features, and advantages of the present disclosure clearer, the following provides a detailed description of specific embodiments of the present disclosure in conjunction with the drawings. Many specific details are elaborated in the following description to provide a thorough understanding of the present disclosure. However, the present disclosure can be implemented in various other ways that differ from the descriptions provided herein. Those skilled in the art can make similar modifications without deviating from the essence of the present disclosure. Therefore, the present disclosure is not limited to the specific embodiments disclosed below.

In the description of the present disclosure, it should be understood that terms such as “center,” “longitudinal,” “transverse,” “length,” “width,” “thickness,” “upper,” “lower,” “front,” “back,” “left,” “right,” “vertical,” “horizontal,” “top,” “bottom,” “inside,” “outside,” “clockwise,” “counterclockwise,” “axial,” “radial,” “circumferential,” etc., indicate directions or positional relationships based on the orientation shown in the figures. These are used only to facilitate the description of the present disclosure and to simplify the description, not to indicate or imply that the devices or components referred to must have a specific orientation, be constructed, or operated in a specific orientation. Thus, these terms should not be interpreted as limiting the present disclosure.

Additionally, terms such as “first” and “second” are used only for description purposes and should not be interpreted as indicating or implying relative importance or suggesting the number of technical features. Features defined with “first” and “second” can explicitly or implicitly include one or more of such features. In the description of the present disclosure, “multiple” means at least two, such as two or three, unless otherwise explicitly defined.

In the present disclosure, unless otherwise explicitly defined and limited, the terms “mount,” “connect,” “link,” “fix,” etc., should be understood in a broad sense. For example, they may refer to fixed connections, detachable connections, or integrally formed connections. They may refer to mechanical or electrical connections; they may be direct or indirect connections through intermediary elements; or they may refer to interactions between two components, unless explicitly limited. Those skilled in the art can understand the specific meanings of these terms in the present disclosure according to specific circumstances.

In the present disclosure, unless otherwise explicitly defined and limited, when a first feature is said to be “above” or “below” a second feature, this may mean that the first and second features are in direct contact, or that the first and second features are indirectly in contact through an intermediary. Additionally, “above,” “upper,” and “on top of” can mean that the first feature is directly or indirectly above the second feature or simply that the first feature is at a higher level. Similarly, “below,” “lower,” and “underneath” can mean that the first feature is directly or indirectly below the second feature or simply that the first feature is at a lower level.

It is worth noting that when a component is described as being “fixed to” or “arranged on” another component, it can be directly on the other component or there can be intervening components in between. When a component is described as being “connected to” another component, it may be directly connected to it or there may be an intermediary. Terms such as “vertical,” “horizontal,” “upper,” “lower,” “left,” “right,” and similar expressions used herein are merely for illustration purposes and do not represent the only possible embodiment.

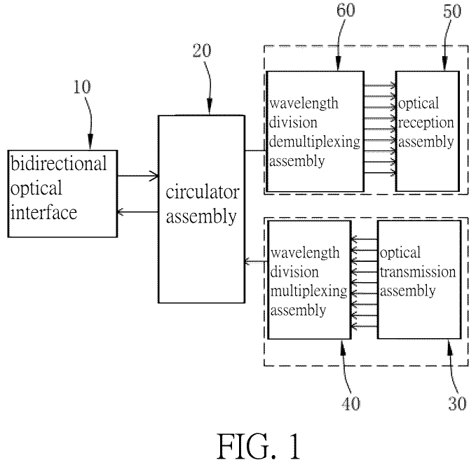

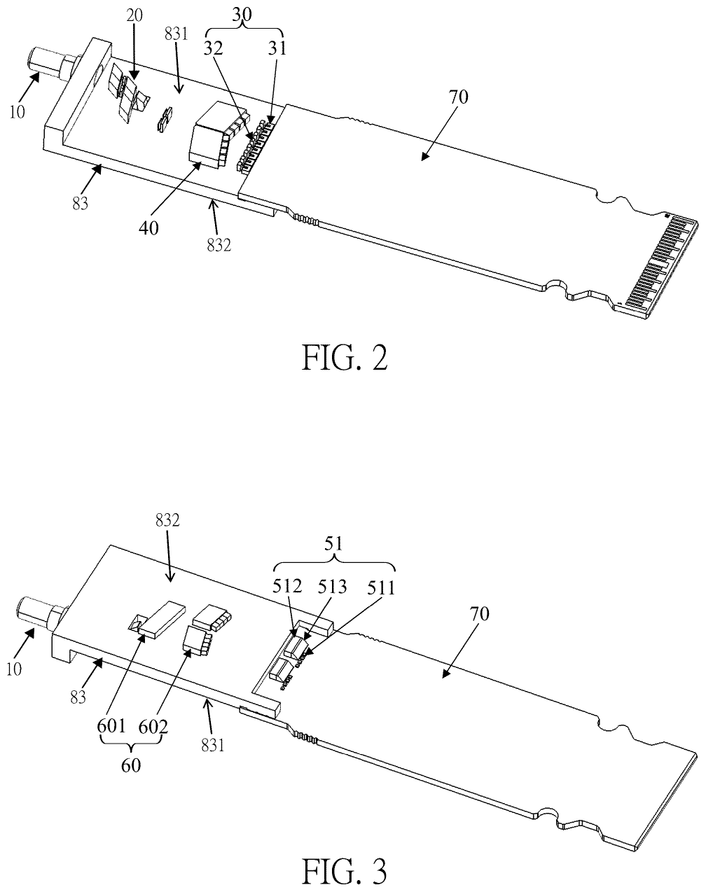

Referring to FIGS. 1-3, the present disclosure provides an optical transceiver module 100, which comprises a housing (not shown), and a bidirectional optical interface 10, a circulator assembly 20, an optical transmission assembly 30, a wavelength division multiplexing assembly 40, an optical reception assembly 50, a wavelength division demultiplexing assembly 60, and a circuit board 70 that are arranged within the housing. The optical transmission assembly 30 and the optical reception assembly 50 are electrically connected to the circuit board 70. Specifically, the optical transmission assembly 30 and the wavelength division multiplexing assembly 40 together form the TX (transmit) end of the optical transceiver module 100, while the optical reception assembly 50 and the wavelength division demultiplexing assembly 60 form the RX (receive) end of the optical transceiver module 100. The bidirectional optical interface 10 is used to transmit combined optical signals transmitted from the TX end to exterior and receive combined optical signals from external sources. Specifically, the bidirectional optical interface 10 can be optically coupled with external optical fibers, so as to output and transmit combined optical signals from the circulator assembly 20 through the external optical fibers, as well as input combined optical signals from external optical fibers into the circulator assembly 20.

The circulator assembly 20 comprises a common optical port, an optical output port, and at least one optical incident port. The common optical port is optically coupled to the bidirectional optical interface 10, the optical output port is optically coupled to the wavelength division demultiplexing assembly 60, and each of optical incident ports is optically coupled to the wavelength division multiplexing assembly 40.

Specifically, the circulator assembly 20 can receive combined optical signals from the wavelength division multiplexing assembly 40 via the optical incident port and output the combined optical signals to the bidirectional optical interface 10 via the common optical port. The circulator assembly 20 can also receive combined optical signals from the bidirectional optical interface 10 via the common optical port and output the combined optical signals to the wavelength division demultiplexing assembly 60 via the optical output port.

In the TX end of the optical transceiver module 100, the optical transmission assembly 30 is used to transmit at least eight transmission-end optical signals. The wavelength division multiplexing assembly 40 is used to multiplex at least eight transmission-end optical signals from the optical transmission assembly 30 into combined optical signals, and then transmit the combined optical signals to the optical incident port.

Specifically, the optical transmission assembly 30 comprises at least eight optical transmission components. For example, each optical transmission component includes but is not limited to a laser that emits P-polarized light or S-polarized light. Both P-polarized light and S-polarized light are linearly polarized light. The optical transmission components respectively transmit one transmission-end optical signal to the wavelength division multiplexing assembly 40. The wavelength division multiplexing assembly 40 multiplexes the multiple transmission-end optical signals into a first combined optical signal, and then input the first combined optical signal to the circulator assembly 20 via the optical incident port.

In the RX end of the optical transceiver module 100, the wavelength division demultiplexing assembly 60 is used to demultiplex the combined optical signal output from the optical output port into at least eight reception-end optical signals, and the optical reception assembly 50 receives these reception-end optical signals from the wavelength division demultiplexing assembly 60.

Specifically, the specific structure of the wavelength division demultiplexing assembly 60 and the optical reception assembly 50 is not limited and can be adaptively adjusted based on actual design needs. For example, in some embodiments, the wavelength division demultiplexing assembly 60 comprises a 1×2 coarse wavelength division demultiplexer 601 and two 1×4 fine wavelength division demultiplexers 602. The two fine wavelength division demultiplexers 602 are coupled to the coarse wavelength division demultiplexer 601, respectively. The coarse wavelength division demultiplexer 601 is configured to demultiplex the combined optical signal output from the optical output port into two combined optical signals and then inputting them into the two fine wavelength division demultiplexers 602, respectively. Each fine wavelength division demultiplexer 602 is configured to demultiplex the corresponding combined optical signal into four single-channel reception-end optical signals. Through the two fine wavelength division demultiplexers 602, eight single-channel reception-end optical signals are output to the optical reception assembly 50. The optical reception assembly 50 comprises at least two optical reception arrays 51. Each optical reception array 51 comprises at least four optical reception elements 511, reception-end coupling lenses 512, and a light reflection prism 513. The optical reception elements 511 include, but are not limited to, laser receivers (such as photodiodes). Each reception-end optical signal is incident on the light reflection prism 513 through the reception-end coupling lens 512, and the multiple optical reception elements 511 are respectively used to receive multiple reception-end optical signals from the wavelength division demultiplexing assembly 60 via the corresponding light reflection prisms 513.

In the optical transceiver module 100 described above, the cooperation between the bidirectional optical interface 10 and the circulator assembly 20 allows the optical transmission assembly 30 and the optical reception assembly 50 to optical couple to the bidirectional optical interface 10 from the same common optical port, enabling bidirectional transmission via the same external optical fiber, which improves the utilization rate of the optical fiber used for network transmission, reduces the number of optical fibers needed, and lowers costs. Furthermore, the reception-end optical signals can use the same wavelength channels as the transmission-end optical signals, which saves wavelength channels compared to commonly used single-fiber bidirectional optical modules, where different wavelength channels are required for transmission and reception.

It should be noted that the structure of the circulator assembly 20 is configured to work in conjunction with the structure of the wavelength division multiplexing assembly 40. The following will provide a detailed description of the specific structure of the circulator assembly 20 and the wavelength division multiplexing assembly 40, but the present disclosure is not limited to the embodiments listed below.

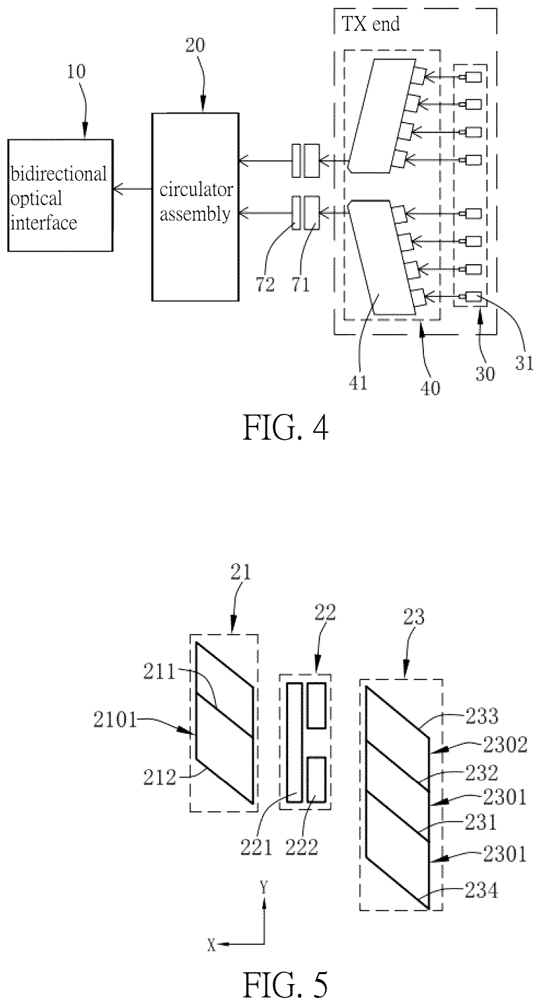

As shown in FIGS. 1-2 and 4-5, in some embodiments, the wavelength division multiplexing assembly 40 comprises at least two four-in-one first multiplexers 41. Each first multiplexer 41 is configured to combine four of the at least eight transmission-end optical signals emitted by the optical transmission assembly 30 into one first combined optical signal for output.

Specifically, taking an optical module with eight optical signal channels as an example, the wavelength division multiplexing assembly 40 comprises two four-in-one first multiplexers 41, and the optical transmission assembly 30 comprises eight optical transmission elements 31. One first multiplexer 41 is optically coupled with four optical transmission elements 31 through a set of transmission-end coupling lenses 32, and the other first multiplexer 41 is optically coupled with the other four optical transmission elements 31 through another set of transmission-end coupling lenses 32. Each first multiplexer 41 receives four transmission-end optical signals emitted by the corresponding four optical transmission elements 31, and combines the four transmission-end optical signals into one first combined optical signal. The two first multiplexers 41 output two first combined optical signals to the circulator assembly 20.

The number of optical incident ports in the circulator assembly 20 matches the number of the first multiplexers 41. For example, in some embodiments, the circulator assembly 20 comprises at least two optical incident ports 2301, with each optical incident port 2301 corresponding to a respective first multiplexer 41.

Each optical incident port 2301 is used to receive the first combined optical signal output from the corresponding first multiplexer 41. Specifically, in some embodiments, for example, the circulator assembly 20 can receive two first combined optical signals from the two first multiplexers 41 through the two optical incident ports 2301, and after combining the two first combined optical signals, the circulator assembly 20 outputs the two first combined optical signals through the common optical port 2101 to the bidirectional optical interface 10.

In some embodiments, the optical transceiver module 100 further comprises an optical isolator 71 and a half-wave plate 72 located between the first multiplexer 41 and the circulator assembly 20. The optical isolator 71 is used to unidirectionally pass the optical signal output from the wavelength division multiplexing assembly 40. For example, the first combined optical signal from each first multiplexer 41 is rotated 45° after passing through the optical isolator 71 and then rotated another 45° after passing through the half-wave plate 72. The first combined optical signal may be rotated in the same direction in the optical isolator 71 and the half-wave plate 72, causing the first combined optical signal to be rotated a total of 90° and changing its polarization state. Alternatively, the first combined optical signal may be rotated in opposite directions in the optical isolator 71 and the half-wave plate 72, resulting in no change in its polarization state. The specific polarization state changes of the first combined optical signal after passing through the optical isolator 71 and the half-wave plate 72 can be set according to the actual design requirements. In this case, the polarization directions of the two first combined optical signals output by the two first multiplexers 41 are perpendicular to each other after passing through the respective optical isolator 71 and the half-wave plate 72, then incident to the circulator assembly as P-polarized light and S-polarized light respectively. The combination of the optical isolator 71 and the half-wave plate 72 not only adjusts the polarization direction of the first combined optical signal but also allows only the forward optical signal to pass, and preventing any reflected light from optical elements behind the optical isolator 71 from returning, thereby avoiding the reflected light from entering the laser chip which could affect the stability of the laser emission.

In the optical module, the optical signals transmitted by the TX end are linearly polarized light with a consistent polarization state. After the wavelength division multiplexing, the combined optical signal remains linearly polarized. After being adjusted by the optical isolators 71 and the half-wave plates 72, the polarization directions of the two combined optical signals become perpendicular to each other, and the two combined optical signals incident to the polarization beam splitting surface through the two optical incident ports and are respectively transmitted and reflected by the polarization beam splitting surface. Meanwhile, the combined optical signal input from outside and received by the common optical port has a random polarization state, meaning that the polarization state of the combined optical signal received by the RX end is random.

As shown in FIGS. 1-2 and 4-6, in some embodiments, the bidirectional optical interface 10 can be optically coupled with the circulator assembly 20 along a first direction (i.e., the X-axis direction), allowing the transmission of combined optical signals between the two in the first direction.

The circulator assembly 20 comprises a first polarization beam splitter assembly 21, a polarization adjustment assembly 22, and a second polarization beam splitter assembly 23, which are arranged sequentially along the first direction. Specifically:

The first polarization beam splitter assembly 21 comprises a first polarization beam splitting surface 211 and a first reflecting surface 212 arranged along the second direction (i.e., the Y-axis direction) in parallel. The common optical port 2101 is provided on the first polarization beam splitter assembly 21. The second direction forms an angle with the first direction, and the angle between the two can be set according to actual design requirements. In this embodiment, the angle between the second direction and the first direction is 90°, meaning they are perpendicular to each other. The first polarization beam splitting surface 211 and the first reflecting surface 212 are arranged in parallel and inclined at a 45° angle to both the first and second directions, allowing optical signals to input to or output from the circulator assembly along the first direction or the second direction. Certainly, in some embodiments, the first polarization beam splitting surface 211 and the first reflecting surface 212 may be inclined at other angles with respect to the first and second directions.

The second polarization beam splitter assembly 23 comprises a second polarization beam splitting surface 231, a third polarization beam splitting surface 232, a second reflecting surface 233, and a third reflecting surface 234, all arranged along the second direction in parallel. The two optical incident ports 2301 and the optical output port 2302 are provided on the same side of the second polarization beam splitter assembly 23 to receive the first combined optical signals output from the two first multiplexers 41. Similarly, in this embodiment, the second polarization beam splitting surface 231, the third polarization beam splitting surface 232, the second reflecting surface 233, and the third reflecting surface 234 are all inclined at a 45° angle to both the first and second directions, allowing optical signals to input to or output from the circulator assembly along the first direction or the second direction.

The polarization adjustment assembly 22 is located between the first polarization beam splitter assembly 21 and the second polarization beam splitter assembly 23, and is used to unidirectionally adjust the polarization direction of the linearly polarized light incident from the first polarization beam splitter assembly 21 to the second polarization beam splitter assembly 23.

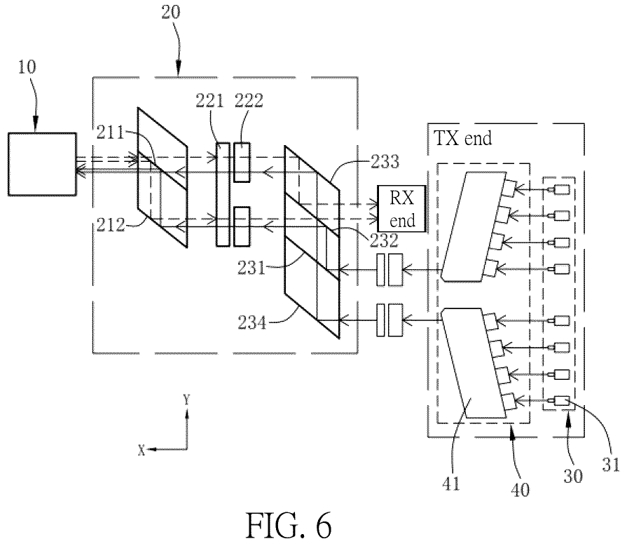

Specifically, the polarization adjustment assembly 22 comprises a half-wave plate 221 and a Faraday rotator 222. The Faraday rotator 222 and the half-wave plate 221 can each rotate the polarization direction of linearly polarized light by a certain angle. For example, in this embodiment, as shown in FIG. 6, the half-wave plate 221 is used to rotate the linearly polarized light 45° to the right. The Faraday rotator 222 rotates linearly polarized light traveling in two opposite directions either 45° to the left or to the right. For instance, the Faraday rotator 222 is used to rotate linearly polarized light traveling from left to right along the first direction by 45° to the right, while also rotating linearly polarized light traveling in the opposite direction (i.e., from right to left along the first direction) by 45° to the left.

By the coordinated arrangement of the Faraday rotator 222 and the half-wave plate 221, the polarization state of the linearly polarized light incident from the second polarization beam splitting assembly 23 to the first polarization beam splitting assembly 21 does not change after passing through the Faraday rotator 222 and the half-wave plate 221. Specifically, the linearly polarized light, traveling from right to left along the first direction, is first rotated 45° to the left by the Faraday rotator 222 and then rotated 45° to the right by the half-wave plate 221. As a result, the total deflection angle of the linearly polarized light after both rotations is 0°, meaning its polarization direction remains unchanged.

As for the linearly polarized light incident from the first polarization beam splitting assembly 21 to the second polarization beam splitting assembly 23, the polarization direction of the linearly polarized light changes by 90° after passing through the half-wave plate 221 and the Faraday rotator 222 in sequence. Specifically, the linearly polarized light, traveling from left to right along the first direction, is first rotated 45° to the right by the half-wave plate 221, and then further rotated 45° to the right by the Faraday rotator 222. Thus, after both rotations, the total deflection angle of the linearly polarized light is 90°, resulting in a change in its polarization direction.

It is worth noting that the specific positions of the Faraday rotator 222 and the half-wave plate 221 are not fixed. For example, in this embodiment, the Faraday rotator 222 can be positioned between the first polarization beam splitting assembly 21 and the second polarization beam splitting assembly 22, while the half-wave plate 221 is positioned between the Faraday rotator 222 and the first polarization beam splitting assembly 21. Additionally, it is also feasible to swap the positions of the Faraday rotator 222 and the half-wave plate 221 based on the configuration in the above embodiment.

In this embodiment, the optical signal transmission principle of the circulator assembly 20 is as follows.

### (1) Transmission of Optical Signals Through the TX End:

The first combined optical signals incident from the two optical incident ports 2301 are combined into a second combined optical signal after sequentially passing through the second polarization beam splitter assembly 23, the polarization adjustment assembly 22, and the first polarization beam splitter assembly 21.

Specifically, the TX end outputs two beams of the first combined optical signal to the two respective optical incident ports 2301. One of the first combined optical signals incident from one of the optical incident ports 2301 is sequentially reflected by the third reflecting surface 234, transmitted through the second polarization beam splitting surface 231 and the third polarization beam splitting surface 232, and then reflected by the second reflecting surface 233. Afterward, the signal is transmitted through the polarization adjustment assembly 22 to the first polarization beam splitting surface 211. The other first combined optical signal incident from the other optical incident port 2301 is sequentially reflected by the second polarization beam splitting surface 231 and the third polarization beam splitting surface 232, then passes through the polarization adjustment assembly 22 to the first reflecting surface 212, and is reflected by the first reflecting surface 212 to the first polarization beam splitting surface 211. The first polarization beam splitting surface 211 reflects the first combined optical signal from the first reflecting surface 212 and transmits the first combined optical signal from the second reflecting surface 233, thus combining the two beams of the first combined optical signal into the second combined optical signal.

Afterwards, the second combined optical signal is then coupled to the bidirectional optical interface 10 through the common optical port 2101.

In this embodiment, the two optical incident ports 2301 and the optical output port 2302 are provided on the side of the second polarization beam splitter assembly 23 adjacent to the wavelength division multiplexing assembly and are positioned along the second direction. The two optical incident ports 2301 are respectively located opposite the third reflecting surface 234 and the second polarization beam splitting surface 231, while the optical output port 2302 is positioned opposite the third polarization beam splitting surface 232. The third reflecting surface 234, the second polarization beam splitting surface 231, the third polarization beam splitting surface 232, and the second reflecting surface 233 are parallel to each other and inclined at a 45° angle to both the first and second directions.

### (2) Reception of Optical Signals Through the RX End:

After the combined optical signal with randomly polarized input from the bidirectional optical interface 10 is split into two beams of linearly polarized light by the first polarization beam splitter assembly 21, the polarization directions of the two linearly polarized beams are adjusted by the polarization adjustment assembly 22, and then are combined into a third combined optical signal by the second polarization beam splitter assembly 23.

Specifically, the combined optical signal input from the bidirectional optical interface 10 incidents to the circulator assembly 20 through the common optical port 2101. The combined optical signal incident through the common optical port 2101 is split into two beams of combined optical signals by the first polarization beam splitting surface 211.

In this case, one beam of the combined optical signal is sequentially reflected by the first polarization beam splitting surface 211 and the first reflecting surface 212, then transmitted to the third polarization beam splitting surface 232 after having its polarization direction adjusted by the polarization adjustment assembly 22. The other beam of the combined optical signal is transmitted through the first polarization beam splitting surface 211, then transmitted to the second reflecting surface 233 after having its polarization direction adjusted by the polarization adjustment assembly 22, and subsequently reflected by the second reflecting surface 233 to the third polarization beam splitting surface 232. The third polarization beam splitting surface 232 reflects the combined optical signal from the second reflecting surface 233 and transmits the combined optical signal from the first reflecting surface 212, and combines the two beams of combined optical signals into a third combined optical signal.

Afterwards, the third combined optical signal is then transmitted through the optical output port 2302 to the RX end, where it is received by the optical reception assembly 50.

In this embodiment, positioning the two optical incident ports 2301 on the same side of the circulator assembly 20 helps reduce the width of the optical transceiver module 100, so as to facilitate a more compact design.

Certainly, in other embodiments (not shown), the two optical incident ports may also be positioned on different sides of the second polarization beam splitting assembly. For example, the two optical incident ports can be set on adjacent sides of the second polarization beam splitting assembly, facing the second polarization beam splitting surface in the first and second directions respectively. In the case where one optical incident port faces the second polarization beam splitting surface in the second direction, the first combined optical signal incident in the second direction can be transmitted sequentially through the second polarization beam splitting surface and the third polarization beam splitting surface, then reflected by the second reflecting surface to the first polarization beam splitting surface. The other optical incident port, facing the second polarization beam splitting surface in the first direction, allows the first combined optical signal incident in the first direction to be sequentially reflected by the second polarization beam splitting surface, the third polarization beam splitting surface, and the first reflecting surface to the first polarization beam splitting surface. The first polarization beam splitting surface reflects the first combined optical signal from the first reflecting surface and transmits the first combined optical signal from the second reflecting surface, so as to combine the two beams of the first combined optical signals into the second combined optical signal. In this embodiment, there is no need to set a third reflecting surface, which simplifies the structure of the circulator assembly.

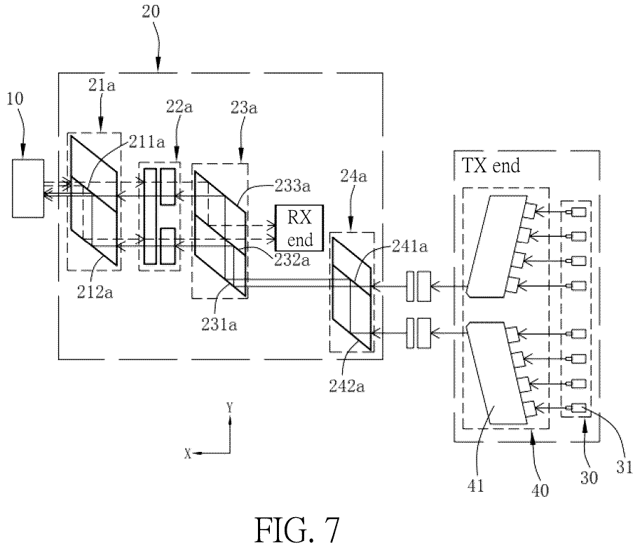

As shown in FIGS. 1 and 7, in some embodiments, the bidirectional optical interface 10 can be optically coupled with the circulator assembly 20 along the first direction (i.e., the X-axis) to achieve the transmission of combined optical signals in the first direction.

The circulator assembly 20 comprises the first polarization beam splitter assembly 21a, the polarization adjustment assembly 22a, the second polarization beam splitter assembly 23a, and the third polarization beam splitter assembly 24a, all arranged sequentially along the first direction.

The first polarization beam splitter assembly 21a comprises the first polarization beam splitting surface 211a and the first reflecting surface 212a, both arranged in parallel along the second direction. The common optical port is located on the first polarization beam splitter assembly. The second direction forms an angle with the first direction, and in this embodiment, the angle is 90°, meaning that the second direction is perpendicular to the first direction. The first polarization beam splitting surface 211a and the first reflecting surface 212a are parallel to each other and inclined at 45° to both the first and second directions. Optical signals can input or output the circulator assembly along either the first or second directions. Certainly, in some embodiments, the first polarization beam splitting surface 211a and the first reflecting surface 212a can be inclined at other angles relative to the first and second directions.

The second polarization beam splitter assembly 23a comprises the second reflecting surface 231a, the second polarization beam splitting surface 232a, and the third reflecting surface 233a, all arranged in parallel along the second direction. The optical output port is located on the second polarization beam splitter assembly 23a. Similarly, in this embodiment, the second reflecting surface 231a, the second polarization beam splitting surface 232a, and the third reflecting surface 233a are all inclined at a 45° angle relative to both the first and second directions. Optical signals can input or output the circulator assembly along either the first or second directions.

The polarization adjustment assembly 22a is located between the first polarization beam splitter assembly 21a and the second polarization beam splitter assembly 23a, and is used to unidirectionally adjust the polarization direction of the linearly polarized light incident from the first polarization beam splitter assembly 21a to the second polarization beam splitter assembly 23a. It is worth noting that the principle behind the polarization adjustment assembly 22a in this embodiment is the same as in the previous embodiments, so it will not be repeated here.

The third polarization beam splitter assembly 24a comprises the third polarization beam splitting surface 241a and the fourth reflecting surface 242a, both arranged in parallel along the second direction. Two optical incident ports are located on the third polarization beam splitter assembly 24a, each used to receive the first combined optical signal output by one of the two first multiplexers 41. The third polarization beam splitting surface 241a and the fourth reflecting surface 242a are both inclined at a 45° angle relative to both of the first direction and the second direction. Optical signals can input or output the circulator assembly along either the first or second directions.

In this embodiment, the optical signal transmission principle of the circulator assembly 20 is as follows.

### (1) Transmission of Optical Signals Via the TX End:

The two first combined optical signals incident from the two optical incident ports are combined into a fourth combined optical signal by the third polarization beam splitter assembly.

Specifically, the TX end outputs two first combined optical signals to the two optical incident ports. The first combined optical signal input through one of the optical incident ports is reflected by the fourth reflecting surface 242a onto the third polarization beam splitting surface 241a. The third polarization beam splitting surface 241a reflects the first combined optical signal from the fourth reflecting surface 242a and transmits the first combined optical signal from the other optical incident port to combine the two first combined optical signals into a fourth combined optical signal.

The fourth combined optical signal is split by the second polarization beam splitter assembly 23a and reflected to the polarization adjustment assembly 22a. The signal is transmitted through the polarization adjustment assembly 22a to the first polarization beam splitter assembly 21a, where it is combined into a fifth combined optical signal by the first polarization beam splitter assembly 21a.

Specifically, the fourth combined optical signal is reflected by the second reflecting surface 231a to the second polarization beam splitting surface 232a, where it is split into two beams of combined optical signals. The second polarization beam splitting surface 232a reflects one beam of the combined optical signal to the polarization adjustment assembly 22a for transmission, and the combined optical signal is then reflected by the first reflecting surface 212a to the first polarization beam splitting surface 211a. The second polarization beam splitting surface 232a transmits the other beam of the combined optical signal to the third reflecting surface 233a, and after being reflected by the third reflecting surface 233a and transmitted through the polarization adjustment assembly 22a, the other beam of the combined optical signal is incident on the first polarization beam splitting surface 211a. The first polarization beam splitting surface 211a reflects the combined optical signal from the first reflecting surface 212a and transmits the combined optical signal from the third reflecting surface 233a, thus combining the two beams of combined optical signals into the fifth combined optical signal.

The fifth combined optical signal is then coupled to the bidirectional optical interface 10 via the common optical port.

### (2) Reception of Optical Signals Through the RX End:

The combined optical signal with randomly polarized input from the bidirectional optical interface 10 is split into two beams of linearly polarized light by the first polarization beam splitting assembly 21a. The two beams of linearly polarized light are respectively adjusted in polarization direction by the polarization adjustment assembly 22a and then combined into a sixth combined optical signal by the second polarization beam splitting assembly 23a.

Specifically, the combined optical signal input from the bidirectional optical interface 10 is incident on the circulator assembly 20 via the common optical port. The combined optical signal incident through the common optical port is split into two beams of combined optical signals by the first polarization beam splitting surface 211a. One of the combined optical signals is successively reflected by the first polarization beam splitting surface 211a and the first reflecting surface 212a, and after the polarization direction is adjusted by the polarization adjustment assembly 22a, the one of the combined optical signals is transmitted to the second polarization beam splitting surface 232a. The other combined optical signal is transmitted through the first polarization beam splitting surface 211a, and after the polarization direction is adjusted by the polarization adjustment assembly 22a, the other combined optical signal is transmitted to the third reflecting surface 233a, and then reflected by the third reflecting surface 233a to the second polarization beam splitting surface 232a. The second polarization beam splitting surface 232a reflects the combined optical signal from the third reflecting surface 233a and transmits the combined optical signal from the first reflecting surface 212a, thereby combining the two combined optical signals into the sixth combined optical signal.

The sixth combined optical signal is then transmitted through the optical output port to the RX end, where it is received by the optical reception assembly 50.

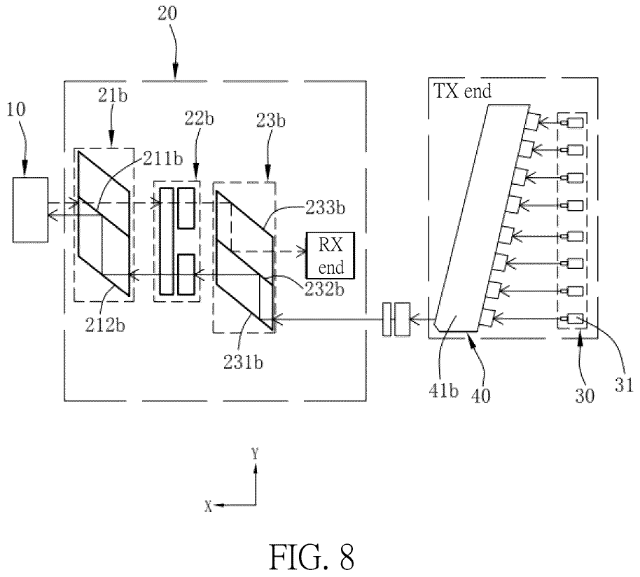

As shown in FIGS. 1 and 8, in some embodiments, the wavelength division multiplexing assembly 40 comprises an 8-in-1 second multiplexer 41b, wherein:

The second multiplexer 41b is used to combine the eight-channel transmission-end optical signals it receives into a seventh combined optical signal and then transmit it to the circulator assembly 20 for emission.

Specifically, the circulator assembly 20 comprises the first polarization beam splitter assembly 21b, the polarization adjustment assembly 22b, and the second polarization beam splitter assembly 23b, all arranged sequentially along the first direction. Wherein:

The first polarization beam splitter assembly 21b comprises a first polarization beam splitting surface 211b and a first reflecting surface 212b, which are arranged in parallel along a second direction. The common optical port is located on the first polarization beam splitter assembly 21b. Wherein, the second direction forms an angle with the first direction, For example, in this embodiment, the angle between the second direction and the first direction is 90°, meaning that the second direction is perpendicular to the first direction. The first polarization beam splitting surface 211b and the first reflecting surface 212b are parallel to each other, and both are inclined at a 45° angle with respect to the first and second directions. The optical signals are input or output along either the first direction or the second direction into or out of the circulator assembly.

The second polarization beam splitter assembly 23b comprises the second reflecting surface 231b, the second polarization beam splitting surface 232b, and the third reflecting surface 233b, all arranged in parallel along the second direction. The optical output port is located on the second polarization beam splitter assembly 23b. The second polarization beam splitter assembly 23b has one optical incident port and one optical output port. Wherein, the second reflecting surface 231b, the second polarization beam splitting surface 232b, and the third reflecting surface 233b are all inclined at 45° relative to both the first and second directions.

The polarization adjustment assembly 22b is positioned between the first polarization beam splitter assembly 21b and the second polarization beam splitter assembly 23b for unidirectionally adjusting the polarization direction of the linearly polarized light incident from the first polarization beam splitter assembly 21b to the second polarization beam splitter assembly 23b. It is worth mentioning that the polarization adjustment principle in this embodiment is the same as in the previous embodiments, so it will not be described in detail here.

In this embodiment, the optical signal transmission principle of the circulator assembly 20 is as follows.

### (1) Transmission of Optical Signals Via the TX End:

The TX end outputs the seventh combined optical signal to the optical incident port. The seventh combined optical signal, incident through the optical incident port, is sequentially reflected by the second reflecting surface 231b and the second polarization beam splitting surface 232b, and then transmitted to the first reflecting surface through the polarization adjustment assembly 22b. The seventh combined optical signal is then reflected by the first reflecting surface 212b and the first polarization beam splitting surface 211b, and finally coupled to the bidirectional optical interface 10 through the common optical port.

### (2) Reception of Optical Signals Through the RX End:

The combined optical signal with randomly polarized input from the bidirectional optical interface 10 is split into two beams of linearly polarized light by the first polarization beam splitting surface 211b. The two beams of linearly polarized light have their polarization directions adjusted by the polarization adjustment assembly 22b, and then are combined into a single combined optical signal by the second polarization beam splitting assembly 23b. Finally, the combined optical signal is transmitted to the RX end through the optical output port, where it is received by the optical reception assembly 50.

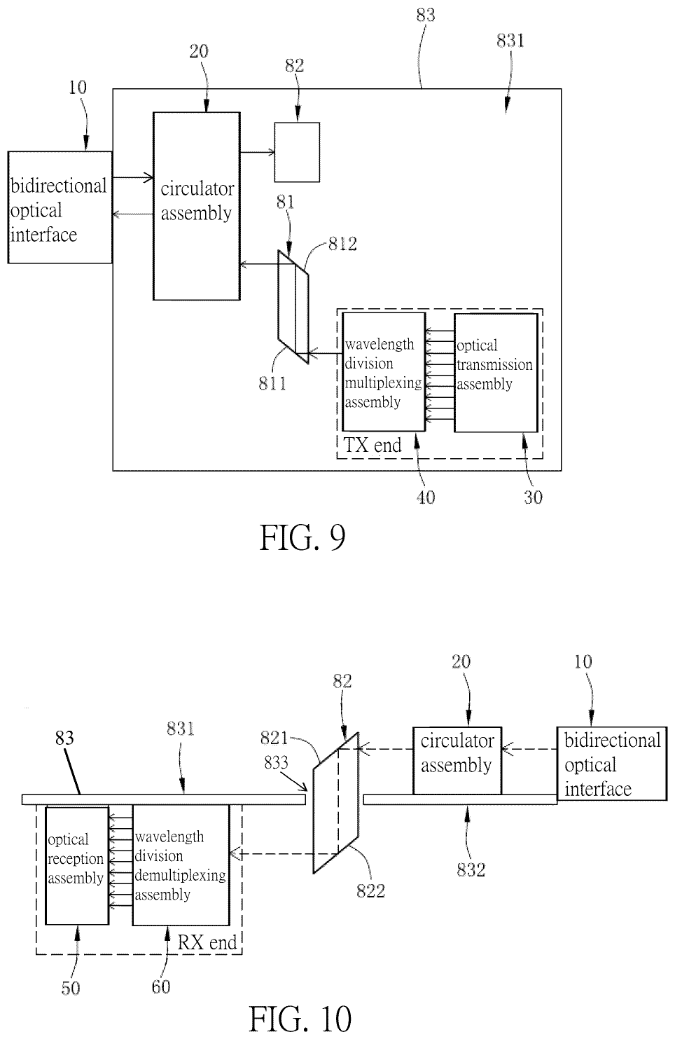

As shown in FIGS. 1, 9, and 10, in some embodiments, the optical transceiver module 100 also comprises a first periscope 81 and a second periscope 82, wherein:

The first periscope 81 is located in the optical path between the optical incident port and the wavelength division multiplexing assembly 40, and is used to deflect the combined optical signal output from the wavelength division multiplexing assembly 40 to the optical incident port. Specifically, the first periscope 81 comprises two opposing reflecting surfaces: a first light incident surface 811 and a first light exit surface 812. The combined optical signal from the wavelength division multiplexing assembly 40 is sequentially reflected by the first light incident surface 811 and the first light exit surface 812 to the optical incident port.

The second periscope 82 is located opposite the optical output port and the wavelength division demultiplexing assembly 60, and is used to output the combined optical signal from the optical output port to the wavelength division demultiplexing assembly 60. Specifically, the second periscope 82 comprises two opposing reflecting surfaces: a second light incident surface 821 and a second light exit surface 822. The combined optical signal from the optical output port is reflected by the second light incident surface 821 and the second light exit surface 822 to the wavelength division demultiplexing assembly 60.

Certainly, it is worth noting that, in other embodiments, it is also possible to configure only one of the first periscope 81 or the second periscope 82, which is feasible and not elaborated here.

In this embodiment, the first periscope enables more flexible positioning between the circulator assembly 20 and the TX end, and/or the second periscope allows for more flexible positioning between the circulator assembly 20 and the RX end, thereby improving the flexibility of positioning the optical elements in the optical transceiver module 100.

In some embodiments, the optical transceiver module 100 further comprises the second periscope 82 and a substrate 83, and the substrate 83 has a first surface side 831 and a second surface side 832 arranged opposite each other.

The bidirectional optical interface 10, the circulator assembly 20, the optical transmission assembly 30, and the wavelength division multiplexing assembly 40 are all arranged on the first surface side 831, so that the bidirectional optical interface 10 and the circulator assembly 20 are positioned on the same side as the optical transmission assembly 30. The optical reception assembly 50 and the wavelength division demultiplexing assembly 60 are positioned on the second surface side 832. The second periscope 82 spans from the first surface side 831 side to the second surface side 832 side of the substrate 83, and is used to deflect the combined optical signal output from the optical output port of the circulator assembly 20 to the wavelength division demultiplexing assembly 60 located on the other surface of the substrate 83. In this embodiment, the substrate 83 is provided with a hole 833 extending through the first surface 831 and the second surface 832. The second periscope 82 is disposed through the hole.

In this embodiment, the second periscope 82 allows the TX and RX ends of the optical transceiver module 100 to be integrated on different sides, which helps to reduce the size of the optical transceiver module 100. Moreover, when integrating more channels of optical components into the housing of the optical module, placing the TX and RX ends on different sides of the substrate 83 can effectively reduce crosstalk between the TX and RX ends as well as crosstalk between adjacent channels on the TX and RX ends.

Certainly, in other embodiments, the bidirectional optical interface 10 and the circulator assembly 20 can also be positioned on the same side of the substrate 83 as the optical reception assembly 50, and the second periscope 82 can be used to deflect the combined optical signal output by the wavelength division multiplexing assembly 40 to the optical incident port of the circulator assembly 20 located on the other side of the substrate 83.

It should be noted that, in some embodiments, the circulator assembly 20, the optical transmission assembly 30, the wavelength division multiplexing assembly 40, the optical reception assembly 50, the wavelength division demultiplexing assembly 60, the first periscope 81, and the second periscope 82 can all be placed on the first surface side 831 of the substrate 83, or all placed on the second surface side 832 of the substrate 83. In this embodiment, the TX and RX ends of the optical transceiver module 100 are integrated on the same side, which simplifies the assembly process of the optical transceiver module 100 and makes it easier to assemble and process, thereby reducing manufacturing costs. It is also worth mentioning that, in other embodiments, the first periscope 81 and/or second periscope 82 may not be included.

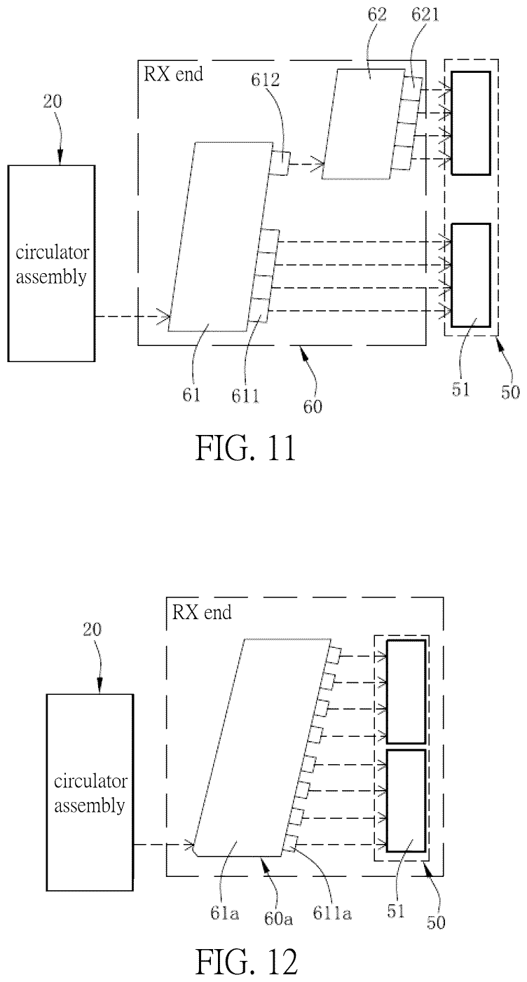

As shown in FIGS. 1 and 11, in some embodiments, the wavelength division demultiplexing assembly 60 comprises a first demultiplexer 61 and a second demultiplexer 62. Wherein:

The first demultiplexer 61 is used to split the combined optical signal output from the optical output port into four single-channel reception-end optical signals and an eighth combined optical signal containing another four-channel optical signal. The four single-channel reception-end optical signals are coupled to the optical reception assembly 50, and the eighth combined optical signal is coupled to the second demultiplexer 62. Specifically, the first demultiplexer 61 comprises four first filters 611 and a second filter 612. The four first filters 611 are optically coupled to the optical reception assembly 50, while the second filter 612 is optically coupled to the second demultiplexer 62. The combined optical signal output from the optical output port passes through the four first filters 611 and then forms the four single-channel reception-end optical signals directed to the optical reception assembly 50. Additionally, an eighth combined optical signal containing another four channels is formed. The eighth combined optical signal is coupled to the second demultiplexer 62 through the second filter 612.

The second demultiplexer 62 is used to split the eighth combined optical signal into another four single-channel reception-end optical signals, which are then output to the optical reception assembly 50. Specifically, the second demultiplexer 62 comprises four third filters 621, and each of the four third filters 621 is optically coupled to the optical reception assembly 50. The eighth combined optical signal passes through the four third filters 621, and forms another four single-channel reception-end optical signals directed to the optical reception assembly 50.

As shown in FIGS. 1 and 12, in some embodiments, the wavelength division demultiplexing assembly 60 comprises a one-to-eight third demultiplexer 61a.

The third demultiplexer 61a is used to split the combined optical signal output from the optical output port into eight single-channel reception-end optical signals, which are then output to the optical reception assembly 50.

Specifically, the third demultiplexer 61a comprises eight fourth filters 611a, and each of the eight fourth filters 611a is optically coupled to the optical reception assembly 50. The combined optical signal output from the optical output port passes through the eight fourth filters 611a, and forms eight single-channel reception-end optical signals directed to the optical reception assembly 50.

The technical features of the above embodiments can be combined in any way. For the sake of brevity, all possible combinations of the technical features in the embodiments described above have not been detailed. However, as long as these combinations do not conflict, they should be considered within the scope described in this specification.

The above embodiments only represent a few examples of the present disclosure. Although the descriptions are specific and detailed, they should not be interpreted as limitations on the scope of the patent. It should be noted that, for those skilled in the art, various modifications and improvements can be made without departing from the spirit of the present disclosure, and these modifications and improvements are all within the scope of protection of the present disclosure. Therefore, the scope of protection for the present disclosure should be based on the appended claims.

1. An optical transceiver module, comprising a housing, and a circuit board, a bidirectional optical interface, a circulator assembly, an optical transmission assembly, a wavelength division multiplexing assembly, an optical reception assembly and a wavelength division demultiplexing assembly that are disposed in the housing,
the optical transmission assembly and the optical reception assembly being electrically connected to the circuit board;
wherein:
the bidirectional optical interface is configured to output a combined optical signal and receiving a combined optical signal input from outside;
the circulator assembly comprises a common optical port, an optical output port, and at least one optical incident port, wherein the common optical port is optically coupled to the bidirectional optical interface, the optical output port is optically coupled to the wavelength division demultiplexing assembly, and each of the optical incident ports is optically coupled to the wavelength division multiplexing assembly;
the optical transmission assembly is configured to transmit at least eight transmission-end optical signals;
the wavelength division multiplexing assembly is configured to combine the at least eight transmission-end optical signals from the optical transmission assembly and transmit them to the optical incident port;
the wavelength division demultiplexing assembly is configured to demultiplex the combined optical signal output from the optical output port into at least eight reception-end optical signals; and
the optical reception assembly is configured to receive the at least eight reception-end optical signals from the wavelength division demultiplexing assembly.

2. The optical transceiver module according to claim 1, wherein, the wavelength division multiplexing assembly comprises at least two four-in-one first multiplexers, each of the first multiplexers being configured to combine four transmission-end optical signals transmitted from the optical transmission assembly into one first combined optical signal and output it.

3. The optical transceiver module according to claim 2, wherein, the circulator assembly comprises at least two optical incident ports, each of the optical incident ports being arranged in one-to-one correspondence with each of the first multiplexers; and
each optical incident port is configured to receive the first combined optical signal output from the first multiplexer corresponding to it.

4. The optical transceiver module according to claim 3, wherein, the circulator assembly comprises a first polarization beam splitter assembly, a polarization adjustment assembly, and a second polarization beam splitter assembly sequentially arranged along a first direction;
the first polarization beam splitter assembly comprises a first polarization beam splitting surface and a first reflecting surface arranged in parallel along a second direction, and the common optical port is provided on the first polarization beam splitter assembly, wherein the second direction is perpendicular to the first direction, and each optical signal is input or output the circulator assembly in the first direction or the second direction;
the second polarization beam splitter assembly comprises a second polarization beam splitting surface, a third polarization beam splitting surface, and a second reflecting surface arranged in parallel along the second direction, and the two optical incident ports and the optical output port are all provided on the second polarization beam splitter assembly and are respectively configured to receive the first combined optical signals output from the two first multiplexers; each of polarization beam splitting surfaces and reflecting surfaces is inclined with respect to the first and second directions;
the polarization adjustment assembly is located between the first polarization beam splitter assembly and the second polarization beam splitter assembly, and is configured to unidirectionally adjust the polarization direction of the linearly polarized light incident from the first polarization beam splitter assembly to the second polarization beam splitter assembly;
the first combined optical signals incident from the two optical incident ports are combined into a second combined optical signal after passing through the second polarization beam splitter assembly, the polarization adjustment assembly, and the first polarization beam splitter assembly in sequence, and the second combined optical signal is coupled to the bidirectional optical interface through the common optical port; and
the combined optical signal incident from the bidirectional optical interface is split by the first polarization beam splitter assembly and adjusted the polarization direction by the polarization adjustment assembly, and then combined into a third combined optical signal by the second polarization beam splitter assembly, and the third combined optical signal is then transmitted to the wavelength division demultiplexing assembly through the optical output port.

5. The optical transceiver module according to claim 3, wherein, the circulator assembly comprises a first polarization beam splitter assembly, a polarization adjustment assembly, a second polarization beam splitter assembly, and a third polarization beam splitter assembly sequentially arranged along the first direction;
the first polarization beam splitter assembly comprises a first polarization beam splitting surface and a first reflecting surface arranged in parallel along the second direction, and the common optical port is provided on the first polarization beam splitter assembly, wherein the second direction is perpendicular to the first direction, and each optical signal is input or output the circulator assembly in the first direction or the second direction;
the second polarization beam splitter assembly comprises a second reflecting surface, a second polarization beam splitting surface, and a third reflecting surface arranged in parallel along the second direction, and the optical output port is provided on the second polarization beam splitter assembly;
the polarization adjustment assembly is located between the first polarization beam splitter assembly and the second polarization beam splitter assembly, and is configured to unidirectionally adjust the polarization direction of the linearly polarized light incident from the first polarization beam splitter assembly to the second polarization beam splitter assembly;
the third polarization beam splitter assembly comprises a third polarization beam splitting surface and a fourth reflecting surface arranged in parallel along the second direction, and the two optical incident ports are provided on the third polarization beam splitter assembly and are respectively configured to receive the first combined optical signals output from the two first multiplexers;
each of polarization beam splitting surfaces and reflecting surfaces is inclined with respect to the first and second directions;
the two first combined optical signals incident from the two optical incident ports are combined into a fourth combined optical signal by the third polarization beam splitter assembly; the fourth combined optical signal is split by the second polarization beam splitter assembly and reflected to the polarization adjustment assembly, transmitted through the polarization adjustment assembly to the first polarization beam splitter assembly, then combined into a fifth combined optical signal by the first polarization beam splitter assembly, and coupled to the bidirectional optical interface through the common optical port; and
the combined optical signal incident from the bidirectional optical interface is split by the first polarization beam splitter assembly, and the polarization direction is adjusted by the polarization adjustment assembly, then the signal is combined into a sixth combined optical signal by the second polarization beam splitter assembly, and the sixth combined optical signal is transmitted to the wavelength division demultiplexing assembly through the optical output port.

6. The optical transceiver module according to claim 1, wherein, the wavelength division multiplexing assembly comprises an eight-in-one second multiplexer, wherein:
the second multiplexer is configured to combine the eight transmission-end optical signals it receives into a seventh combined optical signal and transmit the seventh combined optical signal to the circulator assembly.

7. The optical transceiver module according to claim 1, wherein, the optical transceiver module further comprises a first periscope and/or a second periscope, wherein:
the first periscope is arranged opposite to the optical incident port and the wavelength division multiplexing assembly, and is configured to output the combined optical signal from the wavelength division multiplexing assembly to the optical incident port; and/or,
the second periscope is arranged opposite to the optical output port and the wavelength division multiplexing assembly, and is configured to output the combined optical signal from the optical output port to the wavelength division demultiplexing assembly.

8. The optical transceiver module according to claim 1, wherein, the optical transceiver module further comprises a substrate, the substrate has two surfaces arranged opposite to each other, and the circulator assembly, the optical transmission assembly, the wavelength division multiplexing assembly, the optical reception assembly, and the wavelength division demultiplexing assembly are all disposed on one of the surfaces of the substrate.

9. The optical transceiver module according to claim 1, wherein, the optical transceiver module further comprises a substrate and a second periscope, the substrate has a first surface and a second surface arranged opposite to each other, the optical transmission assembly and the wavelength division multiplexing assembly are disposed on the first surface, and the optical reception assembly and the wavelength division demultiplexing assembly are disposed on the second surface; and
the bidirectional optical interface and the circulator assembly are disposed on either the first surface or the second surface, and the second periscope spans from the first surface side of the substrate to the second surface side to deflect the combined optical signal output from the optical output port of the circulator assembly to the wavelength division demultiplexing assembly on the other surface of the substrate, or to deflect the combined optical signal output from the wavelength division multiplexing assembly to the optical incident port of the circulator assembly on the other surface of the substrate.

10. The optical transceiver module according to claim 1, wherein, an optical isolator is disposed between the wavelength division multiplexing assembly and the optical incident port of the circulator assembly, for unidirectionally passing the optical signal output from the wavelength division multiplexing assembly.

11. The optical transceiver module according to claim 1, wherein, the wavelength division demultiplexing assembly comprises a first demultiplexer and a second demultiplexer;
the first demultiplexer is configured to demultiplex the combined optical signal output from the optical output port into four reception-end optical signals and an eighth combined optical signal, wherein the four reception-end optical signals are coupled to the optical reception assembly, and the eighth combined optical signal is coupled to the second demultiplexer; and
the second demultiplexer is configured to demultiplex the eighth combined optical signal into another four reception-end optical signals and output them to the optical reception assembly.

12. The optical transceiver module according to claim 1, wherein, the wavelength division demultiplexing assembly comprises a one-to-eight third demultiplexer; and
the third demultiplexer is configured to demultiplex the combined optical signal output from the optical output port into eight reception-end optical signals and output the eight reception-end optical signals to the optical reception assembly.
